(19) United States
(12) Patent Application Publication
(10) Pub. No.: US 2019/0229443 A1
(43) Pub. Date: Jul. 25, 2019

(54) Method for Manufacturing Terminal-Equipped Electric Wire and Terminal-Equipped Electric Wire

(71) Applicant: Yazaki Corporation, Tokyo (JP)

(72) Inventor: Masanori Onuma, Makinohara-shi (JP)

(73) Assignee: Yazaki Corporation, Tokyo (JP)

(21) Appl. No.: 16/252,135

(22) Filed: Jan. 18, 2019

(30) Foreign Application Priority Data
Jan. 24, 2018 (JP) 2018-009949

(51) Int. Cl. H01R 4/62; H01R 4/18; H01R 4/70; H01R 13/03

(52) U.S. Cl. CPC H01R 4/62; H01R 4/18; H01R 43/005; H01R 13/03; H01R 4/70

(57) ABSTRACT

There is provided a method for manufacturing a terminal-equipped electric wire to which a terminal fitting is connected. The terminal fitting includes a core wire crimp portion crimped to a core wire of an electric wire, a coating fixing portion fixed to a coating of the electric wire, and a joint portion connecting the core wire crimp portion and the coating fixing portion. The method includes: applying a first resin to a core wire protrusion region located at an end portion of the core wire crimp portion; curing the first resin; applying a second resin to at least a joint region in which the core wire passes through the joint portion; allowing a penetration time to elapse until the second resin penetrates at least around the core wire and among strands constituting the core wire; and curing the second resin.

### CROSS-REFERENCES TO RELATED APPLICATIONS

This application is based on and claims priority from Japanese Patent Application No. 2018-009949 filed on Jan. 24, 2018, the entire contents of which are incorporated herein by reference.

### FIELD

One or more embodiments of the present invention relate to a method for manufacturing a terminal-equipped electric wire, which includes a terminal fitting connected to an end portion thereof, and the terminal-equipped electric wire.

### BACKGROUND

As a method for manufacturing a terminal-equipped electric wire having an end portion, to which a terminal fitting including a core wire crimp portion crimped to a core wire of an electric wire and a coating crimp portion crimped to a coating portion covering the core wire is connected, a method for sealing a connecting portion between the electric wire and the terminal fitting with a resin has been known in the art (for example, see JP-A-2016-225171). According to the above manufacturing method, a resin is applied to cover a connecting portion between an electric wire and a terminal fitting, a viscosity of the applied resin is lowered by using heat to make the resin penetrate between a terminal and a core wire and among strands constituting the core wire, and the resin is entirely cured.

### SUMMARY

However, according to the above manufacturing method, it takes a time to perform a heating process, in which the viscosity of the resin applied to the connecting portion is lowered by heat to make the resin penetrate between the terminal and the core wire and among the strands of the core wire. Therefore, during the heating process, the resin applied onto a tip portion of the core wire, which protrudes from the core wire crimp portion, ends up flowing out. Then, the outflow resin may be attached to an electric connection portion having a contact point and a coupling portion to a connecting counterpart, to thereby degrade connecting reliability. In addition, a thickness of the resin covering an end portion of the core wire may be reduced due to outflow of the resin, and waterproof performance may degrade.

One or more embodiments of the invention have been made in consideration of the above-described circumstances, and an object thereof is to provide a method for manufacturing a terminal-equipped electric wire and to provide a terminal-equipped electric wire, capable of ensuring excellent connecting reliability with respect to a connecting counterpart and excellent waterproof performance at a connecting portion between an electric wire and a terminal fitting.

In order to achieve the above-described object, the features of the method for manufacturing the terminal-equipped electric wire according to one or more embodiments of the present invention will be simply summarized as the following (1) to (3).

(1) A method for manufacturing a terminal-equipped electric wire to which a terminal fitting is connected, the terminal fitting including a core wire crimp portion crimped to a core wire of an electric wire, a coating fixing portion fixed to a coating of the electric wire, and a joint portion connecting the core wire crimp portion and the coating fixing portion,

the method including:

applying a first resin to a core wire protrusion region which is located at an end portion of the core wire crimp portion and in which a tip portion of the core wire protrudes;

curing the first resin;

applying a second resin to at least a joint region in which the core wire passes through the joint portion;

allowing a penetration time to elapse until the second resin applied onto the joint region penetrates at least around the core wire and among strands constituting the core wire; and

curing the second resin.

(2) The method for manufacturing the terminal-equipped electric wire according to (1),

wherein when the second resin is applied to the joint region, the second resin is also applied to the core wire protrusion region.

(3) The method for manufacturing the terminal-equipped electric wire according to (1) or (2),

wherein during the penetration time, the second resin is made to penetrate into a gap between the coating fixing portion and the coating of the electric wire.

According to the method for manufacturing the terminal-equipped electric wire of the above-described (1), in the core wire protrusion region, the first resin is applied during the first resin application process and then rapidly cured during the first resin curing process, and thus, the outflow of the first resin applied on the core wire protrusion region can be prevented. As a result, it is possible to prevent degradation of the connecting reliability which is caused by attaching the first resin to the contact point and the coupling portion of the terminal fitting with respect to a connecting counterpart, and excellent waterproof performance at the tip portion of the core wire protruding from the core wire crimp portion can be ensured.

In the joint region, the second resin is applied during the second resin application process and a penetration time elapses in the resin penetration process, and after that, the second resin is cured through the second resin curing process. Thus, the resin can absolutely penetrate around the core wire passing through the joint region and among the strands constituting the core wire and excellent waterproof performance can be ensured.

That is, it is possible to manufacture the terminal-equipped electric wire having excellent connecting reliability with respect to a connecting counterpart and excellent waterproof performance between the electric wire and the connection portion of the terminal fitting.

According to the method for manufacturing the terminal-equipped electric wire of the above-described (2), since the first resin is applied and cured on the core wire protrusion region and then the second resin is applied and cured, the core wire protrusion region can be sealed by a double-layered structure including the lower layer portion including the first resin and the upper layer portion including the second resin. As a result, it is possible to reliably seal the tip portion of the core wire, which is easy to spread. Moreover, even when there is an air bubble in the lower layer portion including the first resin, the upper layer portion including the second resin can cover the air bubble.

According to the method for manufacturing the terminal-equipped electric wire of the above-described (3), since the second resin penetrates into the gap between the coating fixing portion and the coating of the electric wire, the coating fixing portion and the coating of the electric wire can be firmly fixed by the second resin and influence of an external force applied to the electric wire can be reduced.

In order to achieve the above-described object, the features of the terminal-equipped electric wire according to one or more embodiments of the present invention will be simply summarized as the following (4).

(4) A terminal-equipped electric wire (10) including:

an electric wire including a core wire covered with a coating; and

a terminal fitting connected to an end portion of the electric wire in which the core wire is exposed,

wherein the terminal fitting includes:
a core wire crimp portion crimped to the core wire to crimp the core wire;
a coating fixing portion fixed on the coating; and
a joint portion provided between the core wire crimp portion and the coating fixing portion such that the core wire extending from a coating fixing portion side towards the core wire crimp portion passes through the joint portion,

wherein a core wire protrusion region which is located at an end portion of the core wire crimp portion and in which at least a tip portion of the core wire protrudes, and a joint region in which the core wire passes through the joint portion are covered by a resin, and

wherein the resin applied on the core wire protrusion region includes a lower layer portion on a bottom surface side of the terminal fitting and an upper layer portion stacked on the lower layer portion.

According to the terminal-equipped electric wire of the above-described (4), since the core wire protrusion region in which the tip portion of the core wire protrudes from the core wire crimp portion and the joint region through which the core wire passes are sealed by the resin, the terminal-equipped electric wire having excellent waterproof performance can be manufactured. Since the core wire protrusion region is sealed by the double-layered resin including the lower layer portion Ru at a side of the bottom surface of the terminal fitting and the upper layer portion stacked on the lower layer portion, the excellent waterproof performance at the tip portion of the core wire, which is easy to spread, can be ensured.

According to one or more embodiments of the present invention, it is possible to provide a method for manufacturing a terminal-equipped electric wire and to provide a terminal-equipped electric wire, capable of ensuring excellent connecting reliability with respect to a connecting counterpart and excellent waterproof performance at a connecting portion between an electric wire and a terminal fitting.

Hereinbefore, aspects of the present invention have been described simply. Further, by reading through the following mode to carry out the invention (hereinafter, referred to as an “embodiment”) with reference to the accompanying drawings, details will be further clarified.

### BRIEF DESCRIPTION OF DRAWINGS

FIGS. 1A and 1B are diagrams of a terminal-equipped electric wire according to an embodiment, wherein FIG. 1A is a perspective view of the terminal-equipped electric wire and FIG. 1B is a perspective view of an terminal-equipped electric wire having no resin;

FIG. 2 is a cross-sectional view of a terminal-equipped electric wire in a lengthwise direction;

FIGS. 3A and 3B are diagrams of a wire connection portion of a terminal fitting in a terminal-equipped electric wire, wherein FIG. 3A is a plan view and FIG. 3B is a cross-sectional view in a lengthwise direction;

FIG. 4 is a cross-sectional view of a core wire protrusion region of a terminal-equipped electric wire;

FIG. 5 is a cross-sectional view of a joint region in a terminal-equipped electric wire;

FIG. 6 is a cross-sectional view of a coating fixing region in a terminal-equipped electric wire;

FIG. 7 is a flowchart illustrating a treatment in a process of forming a resin portion;

FIGS. 8A to 8D are diagrams illustrating each treatment in a process of forming a resin portion, and are schematic cross-sectional views in a lengthwise direction of a terminal-equipped electric wire;

FIG. 9 is a diagram for describing positioning of an electric wire with respect to a terminal fitting, as seen from a rear end of the terminal fitting viewed in a sectional view;

FIG. 10 is a schematic cross-sectional view of a part in a terminal-equipped electric wire in a lengthwise direction, according to a reference example;

FIGS. 11A and 11B are diagrams illustrating a modified example of a coating fixing portion, and are cross-sectional views of a coating fixing region in a terminal-equipped electric wire; and

FIG. 12 is a perspective view of a terminal-equipped electric wire for illustrating a modified example of a terminal fitting.

### DETAILED DESCRIPTION

Hereinafter, an embodiment according to the present invention will be described with reference to the drawing.

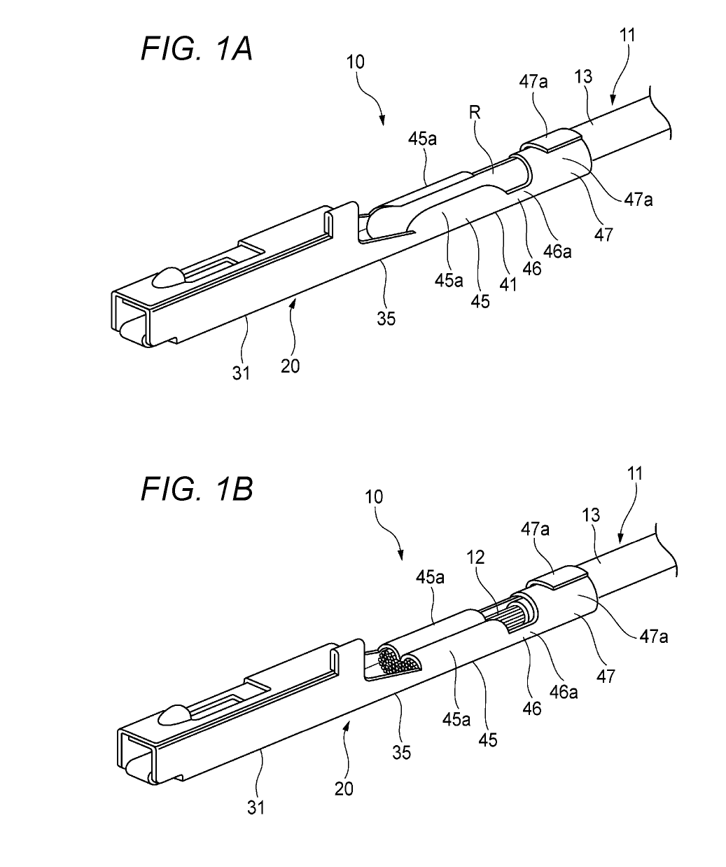

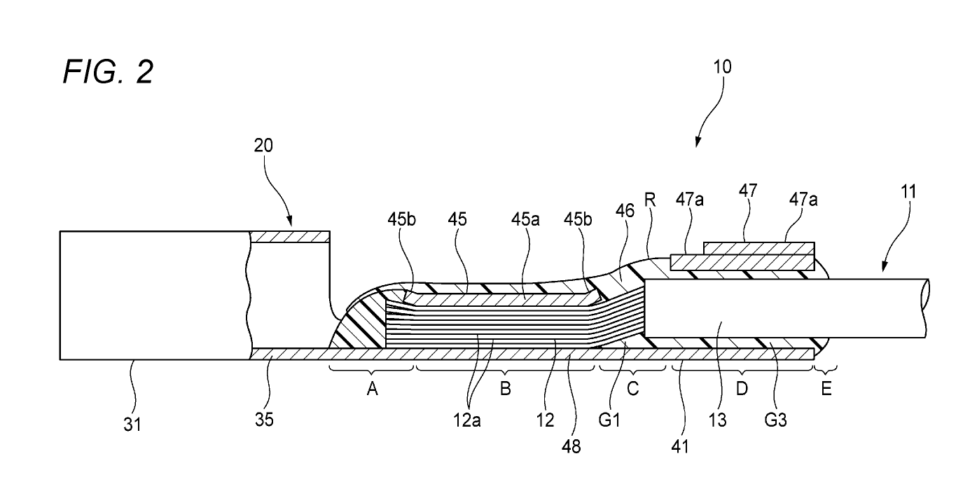

FIGS. 1A and 1B are diagrams of a terminal-equipped electric wire according to an embodiment, wherein FIG. 1A is a perspective view of the terminal-equipped electric wire and FIG. 1B is a perspective view of a terminal-equipped electric wire having no resin. FIG. 2 is a cross-sectional view of the terminal-equipped electric wire in a lengthwise direction.

As shown in FIGS. 1A and 1B and FIG. 2, a terminal-equipped electric wire 10 according to the present embodiment includes an electric wire 11 and a terminal fitting 20. The terminal fitting 20 is electrically connected to an end portion of the electric wire 11. The terminal-equipped electric wire 10 constitutes a wire harness arranged in, for example, a vehicle such as an automobile.

The electric wire 11 is an insulated electric wire including a core wire 12 and a coating 13 made of a resin covering the core wire 12. The core wire 12 is made of aluminum or an aluminum alloy, and is formed by twisting a plurality of strands 12a. When the core wire 12 of the electric wire 11 is made of aluminum or an aluminum alloy, the terminal-equipped electric wire 10 is reduced in weight, and the wire harness including the terminal-equipped electric wire 10 is also reduced in weight. The terminal-equipped electric wire 10 reduced in weight is properly used particularly in a vehicle such as an electric automobile, a hybrid automobile, or the like, which frequently uses the wire harness.

The terminal fitting 20 includes an electric connection portion 31 on a front portion thereof, and a wire connection portion 41 on a rear portion thereof. The electric connection portion 31 and the wire connection portion 41 are connected to each other via a connector 35.

The terminal fitting 20 is formed by performing a pressing (punching process and bending process) on a metal plate including a conductive metal material. The terminal fitting 20 is formed by using, for example, a metal plate made of copper or a copper alloy as a base material.

The electric connection portion 31 is formed as a cylindrical shape with a tip portion opened, and the electric connection portion 31 is electrically connected to a connection counterpart when a tab of a terminal fitting in the connection counterpart is inserted to the opening.

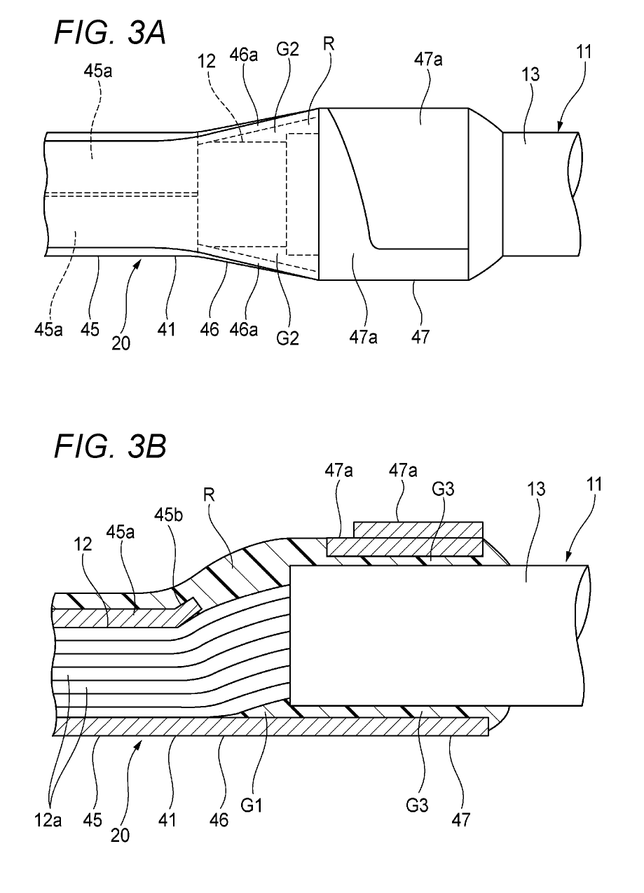

FIGS. 3A and 3B are diagrams of a wire connection portion of a terminal fitting in a terminal-equipped electric wire, wherein FIG. 3A is a plan view and FIG. 3B is a cross-sectional view in a lengthwise direction. As shown in FIGS. 3A and 3B, an end portion of the electric wire 11, from which the core wire 12 is exposed, is electrically connected to the wire connection portion 41. The wire connection portion 41 includes a core wire crimp portion 45, a joint portion 46, and a coating fixing portion 47 sequentially from a side of the electric connection portion 31.

The core wire crimp portion 45 includes a pair of core wire crimping pieces 45a and the coating fixing portion 47 includes a pair of coating fixing pieces 47a. The joint portion 46 is a portion connecting the core wire crimp portion 45 and the coating fixing portion 47 to each other, and includes rising portions 46a at opposite sides thereof for connecting the core wire crimping pieces 45a of the core wire crimp portion 45 and the coating fixing pieces 47a of the coating fixing portion 47 to each other. The core wire crimp portion 45, the joint portion 46, and the coating fixing portion 47 are connected to one another via a bottom plate portion 48.

The core wire crimping pieces 45a are crimped from opposite sides of the core wire crimp portion 45. Then the core wire crimp portion 45 is crimped and electrically connected to the core wire 12 of the electric wire 11. The core wire 12 is crimped and fixed to the core wire crimp portion 45 in a state where the tip portion of the core wire 12 slightly protrudes towards the electric connection portion 31 more than the core wire crimp portion 45.

The core wire crimp portion 45 includes bell mouth portions 45b gradually expanding respectively at an end portion on the side of the electric connection portion 31 and an end portion on the side of the joint portion 46, and thus, the core wire crimping piece 45a is prevented from biting into the core wire 12.

The core wire 12 extending from the coating 13 of the electric wire 11 to the core wire crimp portion 45 passes through the joint portion 46. Also, in the joint portion 46, an end portion of the coating 13 protrudes slightly from the coating fixing portion 47. In the joint portion 46, a gap G1 is provided between the core wire 12 and the bottom plate portion 48 (see FIG. 3B). Also, in the joint portion 46, a gap G2 is provided between the core wire 12 and each of the rising portions 46a in a planar view (see FIG. 3A).

In the coating fixing portion 47, the coating fixing piece 47a is bent so as to wrap around a portion of the coating 13 at the end portion of the electric wire 11 and is crimped such that respective end portions overlap each other. The coating fixing piece 47a of the coating fixing portion 47 is crimped in a state where a gap G3 is formed with respect to the coating 13 of the electric wire 11.

As shown in FIG. 2, in the wire connection portion 41, the core wire 12 is sealed and waterproofed by a resin R. The resin R includes an ultraviolet ray (UV)-curable resin, and is applied through a lengthwise direction of the wire connection portion 41. In detail, the resin R is provided on a core wire protrusion region A closer to the side of the electric connection portion 31 than the core wire crimp portion 45 on the wire connection portion 41, a core wire crimp region B on which the core wire 12 is crimped by the core wire crimp portion 45, a joint region C where the core wire 12 passes through the joint portion 46, a coating fixing region D where the coating fixing piece 47a is crimped around the portion of the coating 13 as the gap G3 is interposed therebetween, and a coating region E at a side of a rear end of the coating fixing portion 47.

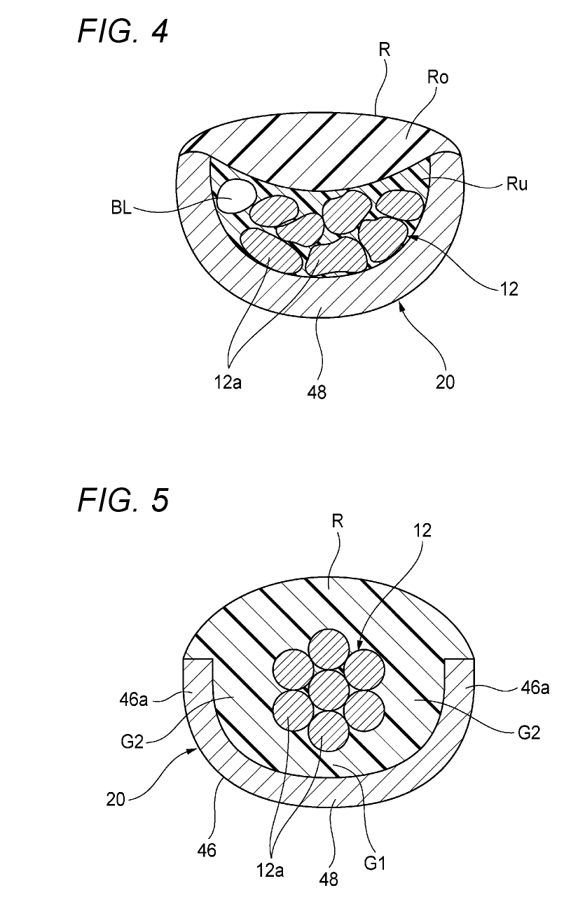

FIG. 4 is a cross-sectional view of a core wire protrusion region of a terminal-equipped electric wire.

As shown in FIG. 4, in the core wire protrusion region A, the tip portion of the core wire 12 protruding from the core wire crimp portion 45 is covered by the resin R. In the core wire protrusion region A, the resin R covering the core wire 12 includes a lower layer portion Ru including a first resin R1 and an upper layer portion Ro including a second resin R2.

In the core wire crimp region B, an abutting portion of the core wire crimping piece 45a is covered by the resin R on an upper portion of the core wire crimp portion 45 that crimps the core wire 12.

FIG. 5 is a cross-sectional view of a joint region in a terminal-equipped electric wire.

As shown in FIG. 5, in the joint region C, the joint portion 46 is buried by the resin R so as to seal the core wire 12. In addition, in the joint region C, the resin R is filled in the gap G1 between the bottom plate portion 48 and the core wire 12, the gap G2 between the core wire 12 and the rising portion 46a, on an upper portion of the core wire 12, and among the strands 12a constituting the core wire 12. Therefore, in the joint region C, the core wire 12 is covered with the resin R.

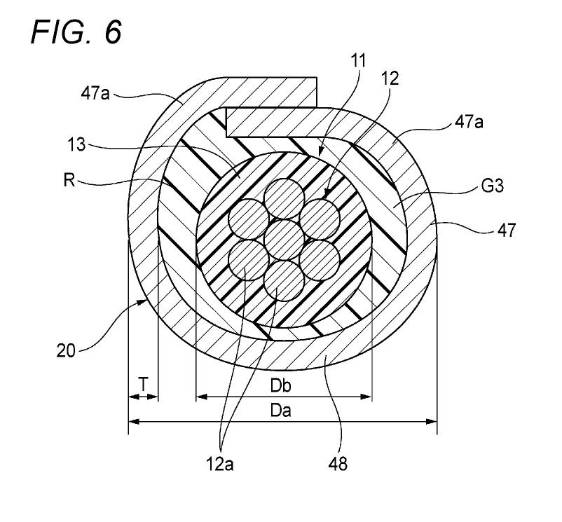

FIG. 6 is a cross-sectional view of a coating fixing region in a terminal-equipped electric wire.

As shown in FIG. 6, in the coating fixing region D, the gap G3 between an outer circumference of the coating 13 and an inner circumference of the coating fixing piece 47a of the coating fixing portion 47 is buried by the resin R. Thus, in the coating fixing region D, the coating 13 of the electric wire 11 and the coating fixing portion 47 are fixed by the resin R over an entire circumference and a longitudinal direction. In the coating fixing portion 47, the resin R filled in the joint portion 46 is not attached to the outer circumference, but penetrates into the gap G3 between the outer circumference and the coating 13, and thus, the gap G3 is buried by the resin R.

In the coating fixing region D, when an outer diameter of the coating fixing portion 47 is Da, an outer diameter of the electric wire 11 is Db, and a thickness of the terminal fitting 20 is T, formula (1) below is satisfied.

Da>Db+2T (1)

In the coating region E, a rear end of the coating fixing portion 47 is buried by the resin R over the entire circumference.

The above terminal-equipped electric wire 10 accommodates the terminal fitting 20 when the terminal fitting 20 is inserted to a cavity of a housing constituting a connector. In addition, by joining connectors to each other, a tab of a terminal fitting of a connecting counterpart is inserted to the opening of the electric connection portion 31 to be electrically connected.

Next, a method of manufacturing the terminal-equipped electric wire 10 will be described below.

(1) Terminal Connection Process

A terminal process for removing the coating 13 at the end portion of the electric wire 12 to expose the core wire 12 is performed.

Then, the end portion of the electric wire 11, on which the terminal process is performed, is arranged on the wire connection portion 41 of the terminal fitting 20, and the core wire crimping piece 45a of the core wire crimp portion 45 and the coating fixing piece 47a of the coating fixing portion 47 are crimped. As a result, the core wire 12 of the electric wire 11 is crimp-connected to the core wire crimp portion 45. Also, the coating fixing piece 47a in the coating fixing portion 47 is crimped to be enclosed such that the gap G3 is formed with respect to the coating 13 of the electric wire 11.

(2) Sealing Process

The resin R is applied to the core wire protrusion region A, the core wire crimp region B, the joint region C, the coating fixing region D, and the coating region E on the wire connection portion 41 of the terminal fitting 20 connected to the end portion of the electric wire 11, so as to seal the core wire 12. In the sealing process, the first resin R1 and the second resin R2 including the same UV-curable resin are applied.

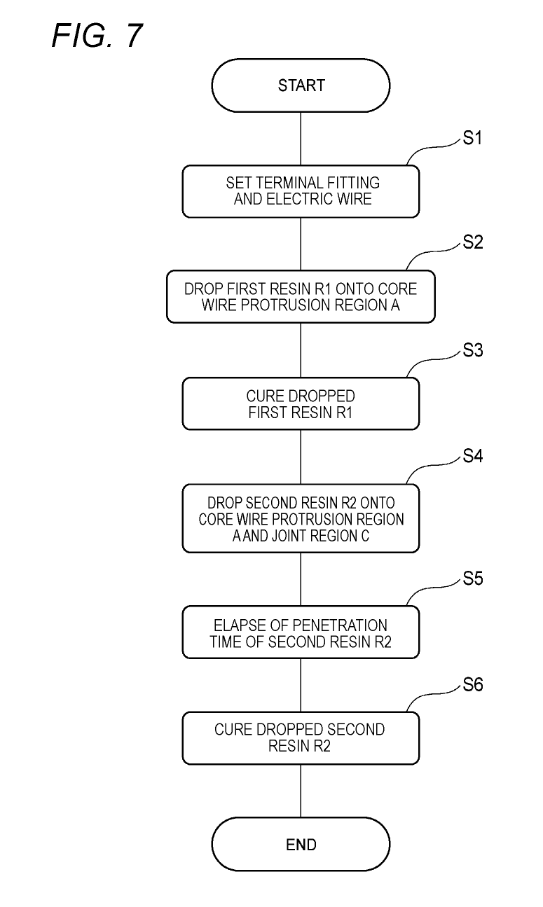

Next, the sealing process will be described in detail with reference to the flowchart of FIG. 7.

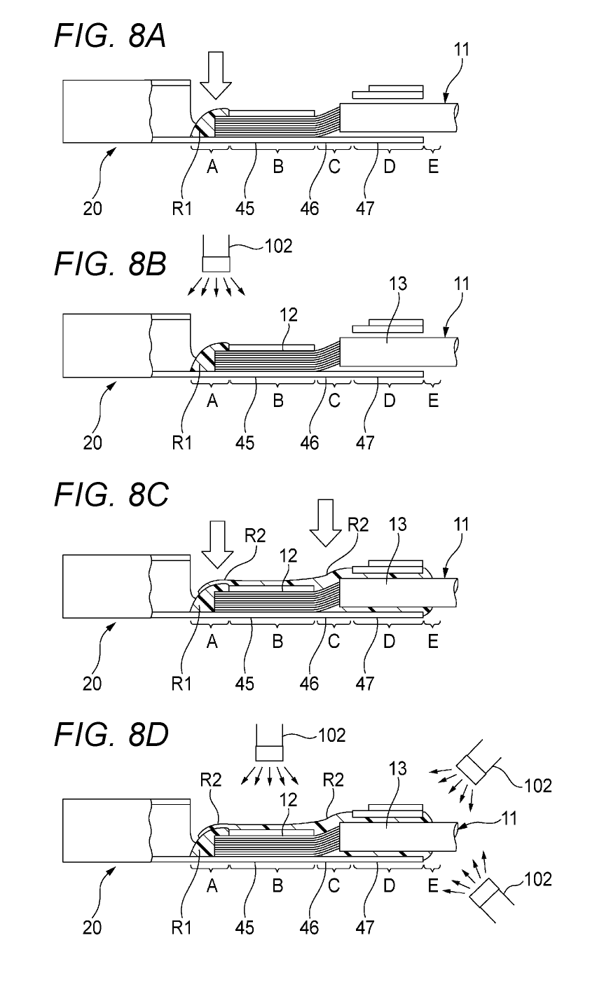

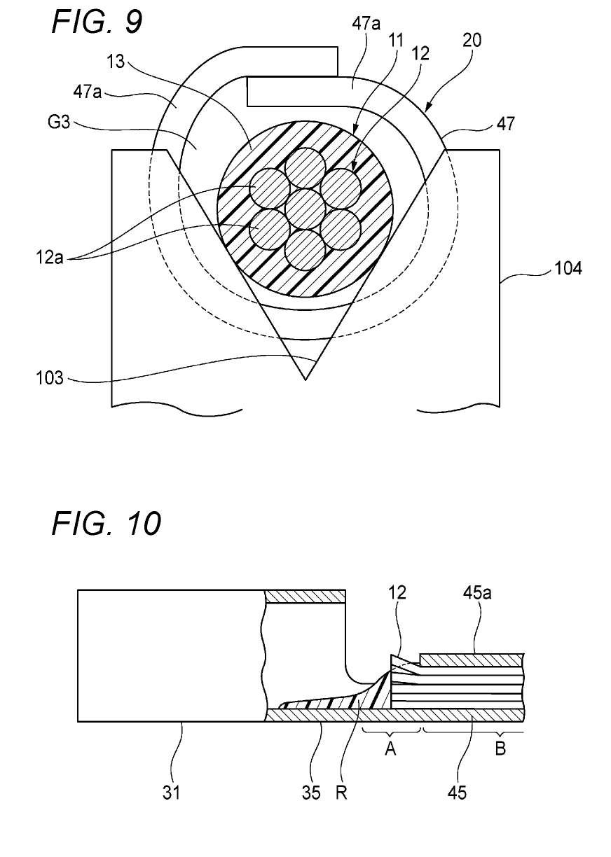

FIG. 7 is a flowchart illustrating a treatment in a process of forming a resin portion. FIGS. 8A to 8D are diagrams illustrating each treatment in a process of forming a resin portion, and are schematic cross-sectional views in a lengthwise direction of a terminal-equipped electric wire. FIG. 9 is a diagram illustrating positioning of an electric wire with respect to a terminal fitting, as seen from a rear end of the terminal fitting viewed in a sectional view.

Process of Applying the First Resin

The terminal fitting 20 connected to the end portion of the electric wire 11 is set in an application device for applying the resin (step S1), and then as shown in FIG. 8A, the first resin R1, that is, the UV-curable resin is applied to the core wire protrusion region A (step S2). Application of the first resin R1 is performed by dropping the first resin R1 from an upper portion of the core wire protrusion region A through a nozzle. By dropping the first resin R1 onto the core wire protrusion region A, the tip portion of the core wire 12 protruding from the core wire crimp portion 45 is covered by the first resin R1 dropped in the core wire protrusion region A.

Process of Curing the First Resin

As shown in FIG. 8B, UV ray is irradiated by a UV irradiator 102 to the first resin R1 that has been applied through the first resin applying process, so as to cure the first resin (step S3). As a result, on the core wire protrusion region A, the first resin R1 covering the tip portion of the core wire 12 is rapidly cured to form the lower layer portion Ru of the resin R.

Process of Applying the Second Resin

As shown in FIG. 8C, the second resin R2, that is, the UV-curable resin, is applied to the core protrusion region A, the core wire crimp region B, the joint region C, the coating fixing region D, and the coating region E (step S4).

Application of the second resin R2 is performed by dropping the second resin R2 from upper portions of the core wire protrusion region A and the joint region C through the nozzle. That is, the second resin R2 is firstly dropped onto the joint region C, and then dropped onto the core wire protrusion region A. An amount of the second resin R2 dropping onto the core wire protrusion region A is less than that of the first resin R1 that has been dropped through the first resin application process.

As shown in FIG. 9, during the process of applying the second resin, the electric wire 11 is supported by a jig 104 including an electric wire supporting recess 103 that has a V-shape widening upward near the terminal fitting 20. Thus, a center of the electric wire 11 is positioned at a center of the coating fixing portion 47 that is crimped so as to wrap around the electric wire 11.

Resin Penetration Process

In order to penetrate the second resin R2 dropped onto the joint region C during the process of applying the second resin, a predetermined penetration time is allowed to elapse (step S5). The penetration time in the resin penetration process is determined according to viscosity of the second resin R2 or the number of strands 12a included in the core wire 12.

The second resin R2 dropped on the joint region C penetrates among the strands 12a of the core wire 12 as the penetration time elapses, and flows into the gap G2 between the core wire 12 and the rising portion 46a and the gap G1 between the bottom plate portion 48 and the core wire 12. Therefore, in the joint region C, the core wire 12 is covered by the second resin R2.

In addition, the second resin R2 dropped onto the joint region C enters the gap G3 between the outer circumference of the coating 13 and the inner circumference of the coating fixing portion 47 as the penetration time elapses, and then penetrates into the rear end portion due to a capillary phenomenon. As a result, in the coating fixing region D, the second resin R2 is filled in the gap G3 between the coating 13 of the electric wire 11 and the coating fixing portion 47 without generating a gap. In addition, the second resin R2 filled in the gap G3 in the coating fixing region D partially escapes from a rear end of the coating fixing portion 47. As a result, in the coating region E, the second resin R2 is applied to the rear end side of the coating fixing portion 47 throughout the entire circumference. In the coating fixing region D, whether the second resin R2 is filled in the gap G3 between the coating 13 of the electric wire 11 and the coating fixing portion 47 without space can be easily identified by visually identifying the second resin R2 escaping over the entire circumference in the coating region E.

The second resin R2 dropped on the joint region C is partially guided towards the core wire protrusion region A along an abutting portion of the core wire crimping piece 45a in the core wire crimp portion 45, due to the capillary effect. Then, the abutting portion of the core wire crimping piece 45a in the core wire crimp region B is covered by the second resin R2. Further, the second resin R2 guided towards the core wire protrusion region A along the abutting portion of the core wire crimping piece 45a is blocked by the lower layer portion Ru formed by the second resin R1 that is cured in the core wire protrusion region A.

Process of Curing the Second Resin

As shown in FIG. 8D, the UV ray is thoroughly irradiated by a plurality of UV irradiators 102 onto the second resin R2 that is applied through the second resin application process and then penetrates into each part through the resin penetration process, so as to cure the second resin R2 (step S6).

As a result, in the core wire protrusion region A, the second resin R2 dropped on the lower layer portion Ru is cured to form the upper layer portion Ro. When the upper layer portion Ro is formed, the core wire 12 is securely covered by the lower layer portion Ru and the upper layer portion Ro in the core wire protrusion region A. Here, in the core wire protrusion region A, since the strands 12a included in the core wire 12 are in dispersed state, an air bubble BL may generate among the strands 12a of the core wire 12 when the first resin R1 is dropped to form the lower layer portion Ru, to thereby degrade the waterproof performance. However, by forming the upper layer portion Ro on the lower layer portion Ru, the lower layer portion Ru is covered by the upper layer portion Ro with the air bubble BL, and thus, a definite waterproof property of the core wire protrusion region A can be ensured.

In the joint region C, the second resin R2 filled in the gap G1 between the bottom plate portion 48 and the core wire 12, the gap G2 between the core wire 12 and the rising portion 46a, on the upper portion of the core wire 12, and among the strands 12a constituting the core wire 12 is cured, and thus, the core wire 12 is covered by the cured second resin R2.

In the coating fixing region D, since the second resin R2 filled in the gap G3 between the outer circumference of the coating 13 and the inner circumference of the coating fixing portion 47 is cured, the coating 13 of the electric wire 11 and the coating fixing portion 47 are firmly fixed by the cured second resin R2 throughout the entire circumference and in the lengthwise direction.

In the coating region E, the second resin R2 escaping over the entire circumference is cured at the rear end of the coating fixing portion 47, and thus, the rear end of the coating fixing portion 47 and the coating 13 are covered throughout the entire circumference.

The terminal-equipped electric wire 10, in which the wire connection portion 41 of the terminal fitting 20 connected to the end portion of the electric wire 11 is covered by the resin R (the first resin R1 and the second resin R2), can be obtained by performing the above-described processes.

Here, the terminal-equipped electric wire 1 shown in FIG. 10 is obtained by dropping and adhering the resin R simultaneously onto the core wire protrusion region A and the joint region C, and allowing the resin R to penetrate around the core wire 12 or among the strands 12a in the joint region C and curing the resin R.

According to the terminal-equipped electric wire 1, when the penetration time taken to allow the resin R to penetrate in the joint region C elapses, the resin R dropped onto the core wire protrusion region A flows out. The outflow resin R may be attached to a contact point of the electric connection portion 31 to thereby reduce connecting reliability. In addition, when the resin R flows out, a thickness of the resin at the tip portion of the core wire 12 is reduced and the waterproof performance may degrade. On the contrary, when the resin R is instantly cured after being applied in order to prevent the outflow of the resin R on the core wire protrusion region A, the resin R may not sufficiently penetrate around the core wire 12 and among the strands 12a in the joint region C, and the waterproof performance degrades.

However, according to the method for manufacturing the terminal-equipped electric wire 10 of the present embodiment, in the core wire protrusion region A, the first resin R1 is applied during the first resin application process and then rapidly cured during the first resin curing process, and thus, the outflow of the first resin R1 applied on the core wire protrusion region A can be prevented. As a result, it is possible to prevent degradation of the connecting reliability which is caused by attaching the first resin R1 to the contact point and the coupling portion of the terminal fitting 20 with respect to a connecting counterpart, and excellent waterproof performance at the tip portion of the core wire 12 protruding from the core wire crimp portion 45 can be ensured.

In the joint region C, the second resin R2 is applied during the second resin application process and a penetration time elapses in the resin penetration process, and after that, the second resin R2 is cured through the second resin curing process. Thus, the resin R can absolutely penetrate around the core wire 12 passing through the joint region C and among the strands 12a constituting the core wire 12 and excellent waterproof performance can be ensured.

That is, it is possible to manufacture the terminal-equipped electric wire 10 having excellent connecting reliability with respect to a connecting counterpart and excellent waterproof performance between the electric wire 11 and the wire connection portion 41 of the terminal fitting 20.

Since the first resin R1 is applied and cured on the core wire protrusion region A and then the second resin R2 is applied and cured, the core wire protrusion region A can be sealed by a double-layered structure including the lower layer portion Ru including the first resin R1 and the upper layer portion Ro including the second resin R2. As a result, it is possible to reliably seal the tip portion of the core wire 12, which is easy to spread. Moreover, even when there is an air bubble BL in the lower layer portion Ru including the first resin R1, the upper layer portion Ro including the second resin R2 can cover the air bubble BL.

Since the second resin R2 penetrates into the gap G3 between the coating fixing portion 47 and the coating 13 of the electric wire 11, the coating fixing portion 47 and the coating 13 of the electric wire 11 can be firmly fixed by the second resin R2 and influence of an external force applied to the electric wire 11 can be reduced.

According to the terminal-equipped electric wire 10 of the present embodiment, since the core wire protrusion region A in which the tip portion of the core wire 12 protrudes from the core wire crimp portion 45 and the joint region C through which the core wire 12 passes are sealed by the resin R (the first region R1 and the second resin R2), the terminal-equipped electric wire 10 having excellent waterproof performance can be manufactured. Since the core wire protrusion region A is sealed by the double-layered resin including the lower layer portion Ru at a side of the bottom surface of the terminal fitting 20 and the upper layer portion Ro stacked on the lower layer portion Ru, the excellent waterproof performance at the tip portion of the core wire 12, which is easy to spread, can be ensured.

In the above embodiment, a structure in which the coating fixing pieces 47a partially overlap each other to enclose the electric wire 11 is exemplarily shown as the coating fixing portion 47; however, a shape of the coating fixing portion 47 is not limited to the example in the above embodiment, provided that the gap G3 may be generated between the portion of the coating 13 of the electric wire 11 and the coating fixing portion 47. In addition, the coating fixing portion 47 may be partially in contact with the coating 13 of the electric wire 11. Alternatively, end portions of the coating fixing pieces 47a in the coating fixing portion 47 may have a gap therebetween without contacting each other.

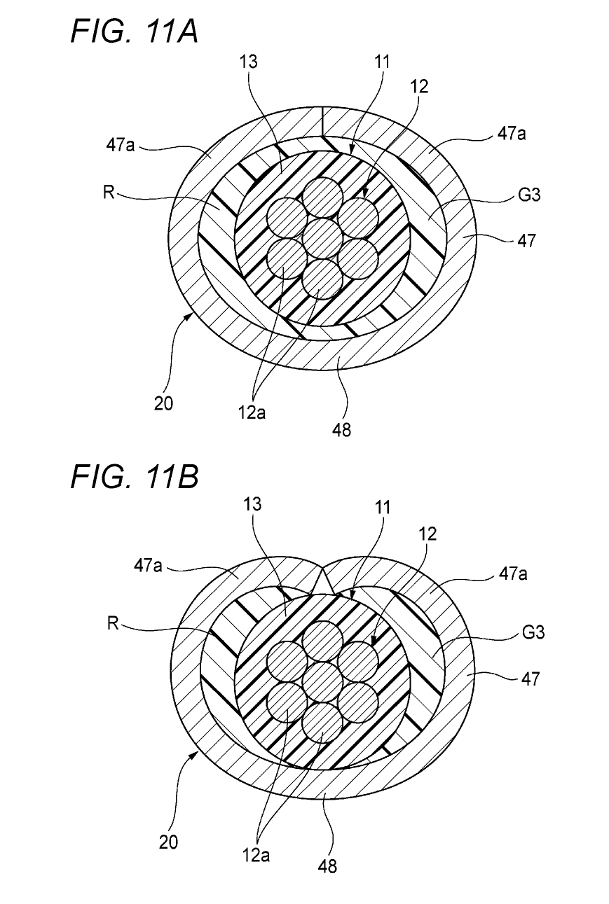

For example, as shown in FIG. 11A, the coating fixing portion 47 may be formed in such a shape that the end portions of the coating fixing pieces 47a abut on each other to surround the electric wire 11, and as shown in FIG. 11B, the end portion of the coating fixing piece 47a may be wound around the electric wire 11 to surround the electric wire 11.

The terminal fitting 20 may not only be inserted to a cavity formed in the housing of the connector, but may be also directly connected to a connecting counterpart.

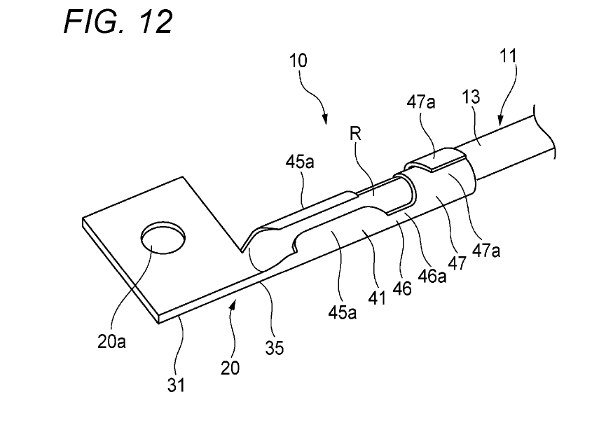

In the above embodiment, an example that the terminal fitting 20 has the electric connection portion 31 of a box-shape in which a tab of a terminal fitting of a counterpart is inserted is shown, and the electric connection portion 31 of the terminal fitting 20 is not limited to the above example. For example, as shown in FIG. 12, a coupling portion having a bolt hole 20a for coupling to the connection counterpart may be provided.

The resin R (the first resin R1 and the second resin R2) is not limited to the UV-curable resin, but may be a thermosetting resin. In this case, in the first resin curing process and the second resin curing process, the applied resin R (the first resin R1 and the second resin R2) is heated to be cured.

The core wire 12 of the electric wire 11 is not limited to the core wire 12 formed of aluminum or an aluminum alloy, but the core wire 12 formed of copper or a copper alloy may be used. In the electric wire 11 having the core wire 12 formed of the aluminum or the aluminum alloy, the galvanic corrosion that may occur when the terminal fitting 20 includes a different metal such as the copper or the copper alloy can be effectively suppressed by the resin R.

It should be noted that the present invention is not limited to the above-described embodiments, and various modifications are included. In addition, materials, shapes, sizes, the number, arrangement place, or the like of each component in the above-described embodiments are arbitrary and not limited as long as they can attain the present invention.

Herein, the features of the method for manufacturing the terminal-equipped electric wire and the terminal-equipped electric wire according to one or more embodiments of the present invention will be simply summarized as the following (1) to (4).

(1) A method for manufacturing a terminal-equipped electric wire (10) to which a terminal fitting (20) is connected, the terminal fitting (20) including a core wire crimp portion (45) crimped to a core wire (12) of an electric wire (11), a coating fixing portion (47) fixed to a coating (13) of the electric wire (11), and a joint portion (46) connecting the core wire crimp portion (45) and the coating fixing portion (47),

the method including:

applying a first resin (R1) to a core wire protrusion region (A) which is located at an end portion of the core wire crimp portion (45) and in which a tip portion of the core wire (12) protrudes;

curing the first resin (R1);

applying a second resin (R2) to at least a joint region (C) in which the core wire (12) passes through the joint portion (46);

allowing a penetration time to elapse until the second resin (R2) applied onto the joint region (C) penetrates at least around the core wire (12) and among strands (12a ) constituting the core wire (12); and

curing the second resin (R2).

(2) The method for manufacturing the terminal-equipped electric wire according to (1),

wherein when the second resin (R2) is applied to the joint region (C), the second resin (R2) is also applied to the core wire protrusion region (A).

(3) The method for manufacturing the terminal-equipped electric wire according to (1) or (2),

wherein during the penetration time, the second resin (R2) is made to penetrate into a gap (G3) between the coating fixing portion (47) and the coating (13) of the electric wire (11).

(4) A Terminal-Equipped Electric Wire (10) Including:

an electric wire (11) including a core wire (12) covered with a coating (13); and

a terminal fitting (20) connected to an end portion of the electric wire (11) in which the core wire (12) is exposed,

wherein the terminal fitting (20) includes:
a core wire crimp portion (45) crimped to the core wire (12) to crimp the core wire (12);
a coating fixing portion (47) fixed on the coating (13); and
a joint portion (46) provided between the core wire crimp portion (45) and the coating fixing portion (47) such that the core wire (12) extending from a coating fixing portion (47) side towards the core wire crimp portion (45) passes through the joint portion (46),

wherein a core wire protrusion region (A) which is located at an end portion of the core wire crimp portion (45) and in which at least a tip portion of the core wire (12) protrudes, and a joint region (C) in which the core wire (12) passes through the joint portion (46) are covered by a resin (R), and

wherein the resin (R) applied on the core wire protrusion region (A) includes a lower layer portion (Ru) on a bottom surface side of the terminal fitting (20) and an upper layer portion (Ro) stacked on the lower layer portion (Ru).

1. A method for manufacturing a terminal-equipped electric wire to which a terminal fitting is connected, the terminal fitting comprising a core wire crimp portion crimped to a core wire of an electric wire, a coating fixing portion fixed to a coating of the electric wire, and a joint portion connecting the core wire crimp portion and the coating fixing portion,
the method comprising:
applying a first resin to a core wire protrusion region which is located at an end portion of the core wire crimp portion and in which a tip portion of the core wire protrudes;
curing the first resin;
applying a second resin to at least a joint region in which the core wire passes through the joint portion;
allowing a penetration time to elapse until the second resin applied onto the joint region penetrates at least around the core wire and among strands constituting the core wire; and
curing the second resin.

2. The method for manufacturing the terminal-equipped electric wire according to claim 1,
wherein when the second resin is applied to the joint region, the second resin is also applied to the core wire protrusion region.

3. The method for manufacturing the terminal-equipped electric wire according to claim 1,
wherein during the penetration time, the second resin is made to penetrate into a gap between the coating fixing portion and the coating of the electric wire.

4. A terminal-equipped electric wire comprising:
an electric wire comprising a core wire covered with a coating; and
a terminal fitting connected to an end portion of the electric wire in which the core wire is exposed,
wherein the terminal fitting comprises:
a core wire crimp portion crimped to the core wire to crimp the core wire;
a coating fixing portion fixed on the coating; and
a joint portion provided between the core wire crimp portion and the coating fixing portion such that the core wire extending from a coating fixing portion side towards the core wire crimp portion passes through the joint portion,
wherein a core wire protrusion region which is located at an end portion of the core wire crimp portion and in which at least a tip portion of the core wire protrudes, and a joint region in which the core wire passes through the joint portion are covered by a resin, and
wherein the resin applied on the core wire protrusion region comprises a lower layer portion on a bottom surface side of the terminal fitting and an upper layer portion stacked on the lower layer portion.
